(19) United States
(12) Patent Application Publication
(10) Pub. No.: US 2008/0126754 A1
(43) Pub. Date: May 29, 2008

(54) Multiple-microcontroller pipeline instruction execution method

(75) Inventor: Jung-Lin Chang, HsinChu (TW)

Correspondence Address: Tung & Associates, Suite 120, 838 W. Long Lake Road, Bloomfield Hille, MI, 48302, US

(73) Assignee: PADAUK Technologies Corporation, R.O.C.

(21) Appl. No.: 11/495,347

(22) Filed: Jul. 28, 2006

(51) Int. Cl. G06F 9/38

(52) U.S. Cl. 712/205; 712/E09.045

(57) ABSTRACT

The present invention discloses a multiple-microcontroller pipeline instruction execution method, wherein the multiple-microcontroller includes a plurality of MCUs, the method comprising: fetching an instruction by a first MCU in a first instruction cycle, and fetching another instruction by a second MCU in a second instruction cycle immediately following the first instruction cycle. At least a subset of the MCUs fetch instructions in turn, each in a corresponding instruction cycle. Or, at least one of the MCUs fetches a next instruction only after it has completed the execution stage of a previous instruction.

### BACKGROUND OF THE INVENTION

1. Field of the Invention

The present invention relates to a multiple-microcontroller pipeline instruction execution method.

2. Description of the Related Art

In order to maximize the performance of a microcontroller, a so-called “pipeline instruction execution method” has been proposed, which divides an instruction into several phases in which each phase of the instruction requires a different execution action, and is executed by different circuit parts. By this arrangement, different phases of different instructions may be processed by different circuit parts concurrently to enhance performance. Such an arrangement is similar to manufacturing products by multiple production lines, and therefore is called “pipeline” instruction execution method.

Referring to FIG. 1, a conventional 3-stage pipeline instruction execution method is shown, which divides an instruction into three phases. The square wave shown on top of the figure represents the instruction cycles, in which a positive pulse and a negative pulse make up one instruction cycle. An “instruction cycle” is a time period wherein a microcontroller, according to its design, may complete a certain action of an instruction; an instruction cycle does not necessarily be a clock cycle, and often it equals to more than one clock cycle.

In the shown 3-stage pipeline instruction execution method, it divides an instruction into an instruction pre-fetching stage, an execution stage, and a write-back stage. As shown in the figure, since the three stages are executed by different circuit parts, it may be thus arranged so that in the first instruction cycle, an instruction N is fetched by circuit parts responsible for fetching instructions; in the second instruction cycle, the instruction N is executed, and the circuit parts responsible for fetching instructions fetch the next instruction N+1; in the third instruction cycle, the instruction N+2 is fetched, the instruction N+1 is executed, and the result of the instruction N is written back. The microcontroller sequentially executes the instructions in the above-described manner.

What FIG. 1 shows is the ideal condition. However, in a practical case, non-ideal condition may occur as shown in FIG. 2. As shown in the figure, instructions of a program are not always sequential. In fact, statistically, about 12% of the instructions in a program are non-sequential, which may be instructions such as jump, call, interrupt, interrupt return, etc. If the instruction N is a non-sequential instruction, as shown in the figure, during the second instruction cycle, the microcontroller automatically fetches the next instruction N+1, but only after the execution phase of the instruction N is completed (i.e., in the third instruction cycle) that the microcontroller discovers what it should process is actually the instruction M, not the instruction N+1. Actions relevant to the instruction N+1 have to be cancelled (i.e., not to be executed, or executed but not written back). In other words, the automatic fetching of the instruction N+1 does not save time but wastes an instruction cycle.

The above-mentioned 3-stage pipeline instruction execution method is relatively simple; a more-stage pipeline instruction execution method is more complex and it will have to face a more severe problem.

FIG. 3 shows a conventional 5-stage pipeline instruction execution method, which divides an instruction into five phases: an instruction pre-fetching stage, a decoding stage, a register fetching stage, an execution stage, and a write-back stage. As shown in the figure, only after the execution stage of the instruction N is completed that the microcontroller discovers what it should process is actually the instruction M, not the instruction N+1; therefore, all the pre-fetched instructions N+1, N+2 and N+3 have to be cancelled. Three instruction cycles are thus wasted.

FIG. 4 shows a conventional 8-stage pipeline instruction execution method, which divides an instruction into eight phases: a first instruction fetching stage, a second instruction fetching stage, a register fetching stage, an address generation stage, a first execution/memory access stage, a second execution/memory access stage, an exception handling stage, and a write-back stage. As shown in the figure, only after the second execution stage of the instruction N is completed that the microcontroller discovers what it should process is the instruction M; therefore, the number of wasted instruction cycles are as high as five.

As above-mentioned, assuming 12% of the instructions being non-sequential, in the 3-stage pipeline instruction execution method, there are 12% of the instructions each wasting one instruction cycle, i.e., 12% of the instruction cycles are wasted, for a total efficiency loss of about 12/(100+12)=10.7%. In the 5-stage pipeline instruction execution method, there are 12% of the instructions each wasting three instruction cycles, i.e., 36% of the instruction cycles are wasted, for a total efficiency loss of about 36/(100+36)=26.5%. in the 8-stage pipeline instruction execution method, there are 12% of the instructions each wasting five instruction cycle, i.e., 60% of the instruction cycles are wasted, for a total efficiency loss of about 60/(100+60)=37.5%. A very high-level microcontroller may divide an instruction into even more than 20 phases, and the possible waste of instruction cycles is huge.

A conventional solution to the above-mentioned problem is to design an instruction prediction circuit which predicts whether the next instruction requires a “jump”, (i.e., the present instruction is a non-sequential instruction), and if yes, where it may “jump” to. To make such prediction precise, the circuit has to retain a track record of the instructions and do real-time analysis to accurately “guess” where the next instruction may be. As such, the circuit design is very complicated, and the required memory size is large, occupying a relatively large circuit area. On the other hand, if the instruction prediction circuit is designed to cope with the simplicity and the miniature of the microcontroller, the accuracy of its prediction drops unavoidably. Furthermore, it is not 100% accurate even for the most accurate instruction prediction circuit; it still has a certain range of inaccuracy. Indeed an inaccurate instruction prediction circuit may still help to increase the efficiency of a microcontroller, but it is not helpful to those application programs which require accurate timing control, such as engine ignition, movement of clock second hand, etc. To these application programs, “certainty” is of the most concern; a programmer needs to control the microcontroller so that it performs a precise action in a precise timing. However, the instruction prediction circuit is beyond the programmer's control; thus, even if the accuracy of the instruction prediction circuit is as high as 99%, the 1% inaccuracy still causes difficulties in programming.

The above-mentioned problems exist in both the conventional microcontrollers and multiple-microcontrollers.

In view of the foregoing, the present invention proposes a pipeline instruction execution method for a multiple-microcontroller which, as compared with conventional multiple-microcontrollers, has a better efficiency, and a stable instruction execution timing, to facilitate programming.

### SUMMARY OF THE INVENTION

A first objective of the present invention is to provide a pipeline instruction execution method for a multiple-microcontroller, in which the microcontroller units (MCUs) of the multiple-microcontroller fetch corresponding instructions in turn, so that instructions are less likely cancelled.

A second objective of the present invention is to provide a pipeline instruction execution method for a multiple-microcontroller, in which at least one MCU is capable of precisely executing a program that requires precise timing control.

To achieve the foregoing objectives, according to the present invention, a pipeline instruction execution method for a multiple-microcontroller having a plurality of MCUs comprises: fetching a first instruction by a first one of the MCUs in a first instruction cycle; and fetching a second instruction by a second one of the MCUs in a second instruction cycle immediately following said first instruction cycle.

According to a preferred embodiment of the present invention, the plurality of MCUs respectively fetch corresponding instructions in turn, each in a corresponding instruction cycle. According to another preferred embodiment of the present invention, a subset of the plurality of MCUs respectively fetch corresponding instructions in turn, each in a corresponding instruction cycle, while another subset of the plurality of MCUs fetch instructions in a different frequency than that of the previous subset. According to a still other preferred embodiment of the present invention, at least one of the plurality of MCUs fetches an instruction only after it has completed the execution stage of an immediately previous instruction.

It should be noted that in the context of the present invention, “to complete an execution stage (phase)” means that an instruction has been processed till a stage where the address of a next instruction is obtained; “to complete an execution stage” does not necessarily have to complete all the actions required for an instruction. In certain arrangements to divide an instruction into multiple phases, the address of a next instruction is obtained before the last execution stage of multiple execution stages, or even obtained during a stage which is not called “execution stage”; however, any stage during which the address of a next instruction is obtained, is equivalent to the “execution stage” defined in the present invention.

For better understanding the objectives, characteristics, and effects of the present invention, the present invention will be described below in detail by illustrative embodiments with reference to the attached drawings.

### BRIEF DESCRIPTION OF THE DRAWINGS

FIG. 1 shows a conventional 3-stage pipeline instruction execution method.

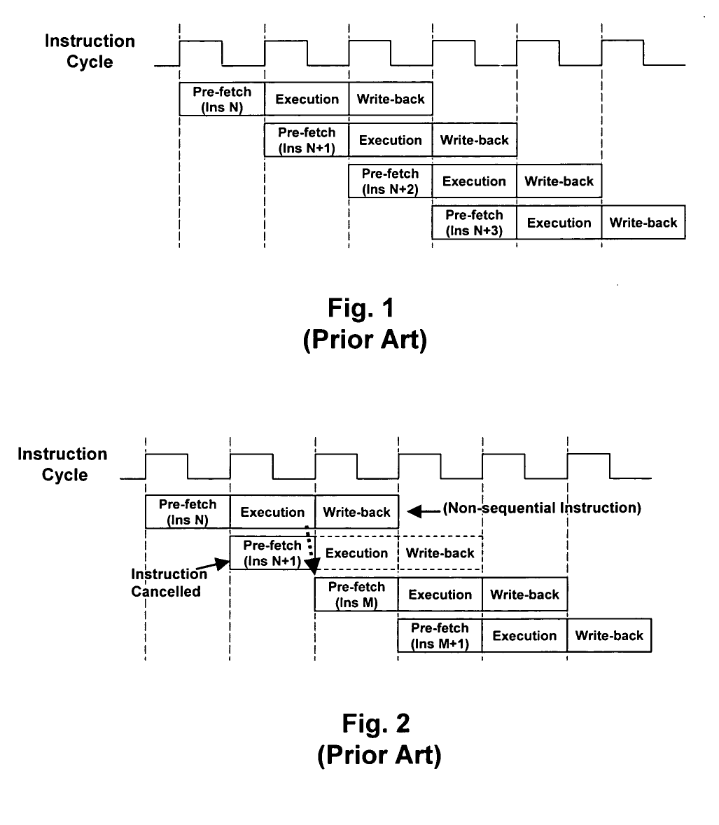

FIG. 2 explains a non-ideal condition wherein the conventional 3-stage pipeline instruction execution method has to waste an instruction cycle when there is a non-sequential instruction.

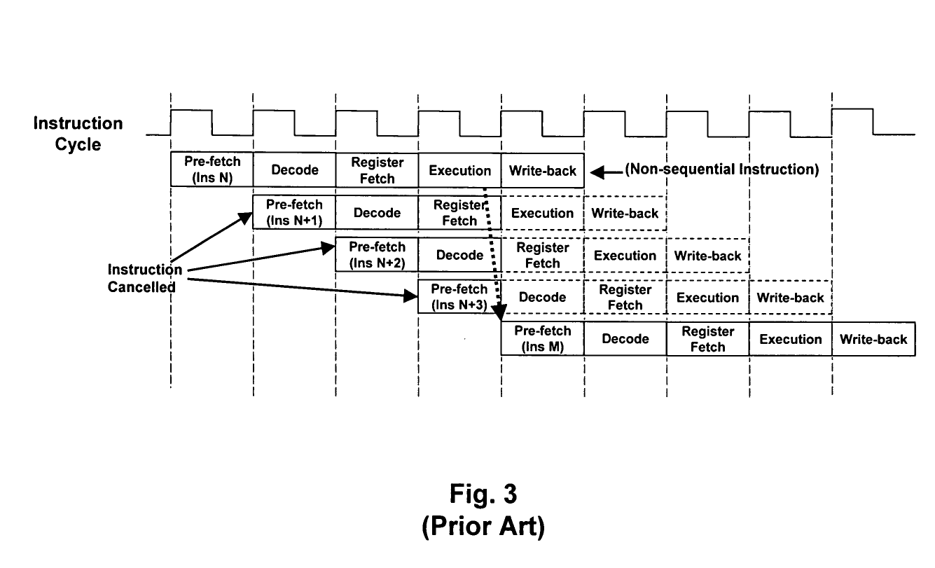

FIG. 3 explains a non-ideal condition wherein the conventional 5-stage pipeline instruction execution method has to waste instruction cycles when there is a non-sequential instruction.

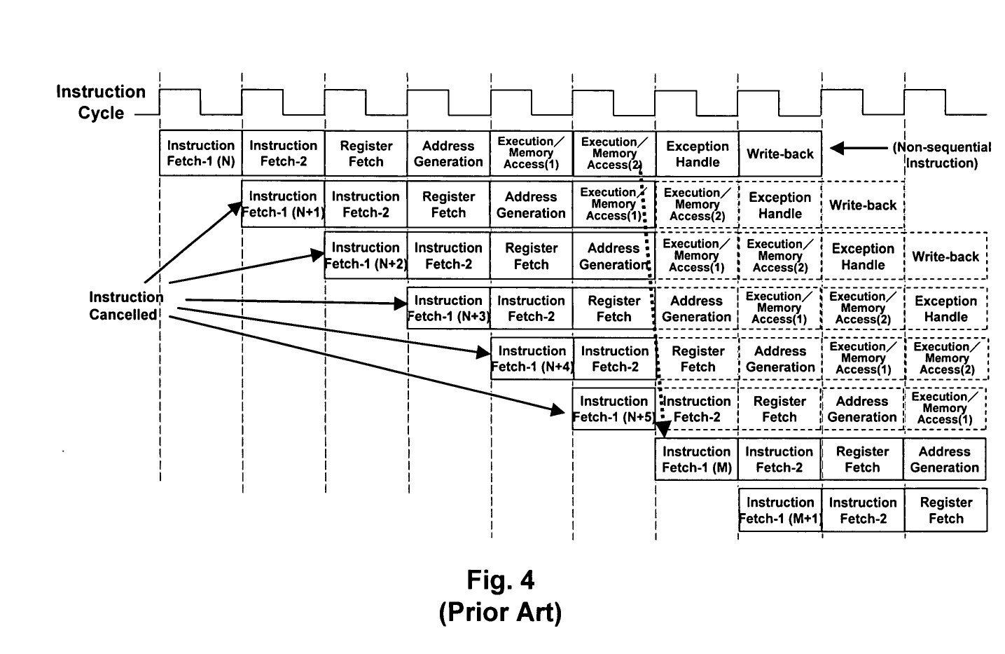

FIG. 4 explains a non-ideal condition wherein the conventional 8-stage pipeline instruction execution method has to waste even more instruction cycles when there is a non-sequential instruction.

FIG. 5 shows a preferred embodiment according to the present invention which is employed in a multiple-microcontroller having two MCUs and applying a 3-stage pipeline instruction execution method.

FIGS. 6 and 7 respectively show two other preferred embodiments according to the present invention.

FIGS. 8 and 9 respectively show two still other preferred embodiments according to the present invention, which show that the present invention has better efficiency even if instruction cancellation still occurs.

FIG. 10 shows another preferred embodiment according to the present invention, illustrating that the instruction cycles may be unevenly shared by the MCUs.

### DESCRIPTION OF THE PREFERRED EMBODIMENT

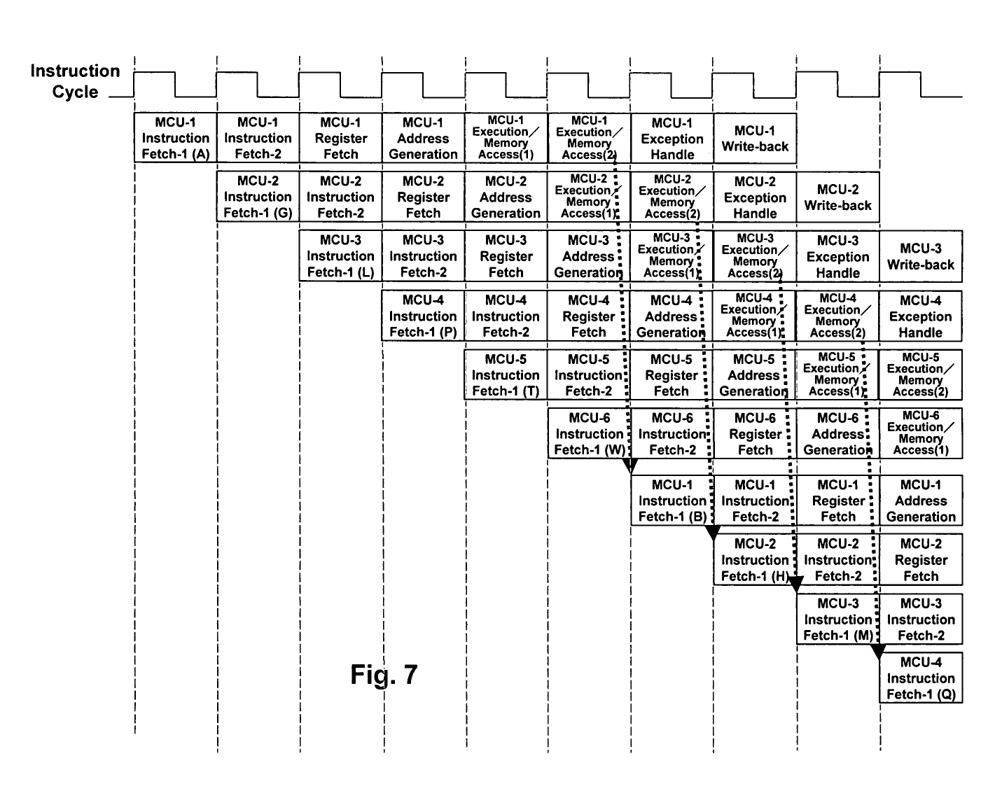

FIG. 5 schematically shows a preferred embodiment according to the present invention, which is employed in a multiple-microcontroller having two MCUs and applying a 3-stage pipeline instruction execution method. As shown in the figure, one of the key features of this embodiment is that each of the MCUs fetches corresponding instructions in turn, that is, in the first instruction cycle, the first MCU (MCU-1) fetches the instruction A, and in the second instruction cycle, the second MCU (MCU-2) fetches the instruction T. In the second instruction cycle, concurrently, the first MCU (MCU-1) has completed the execution phase of the instruction A, so in the third instruction cycle, it is already known that the next instruction of the first MCU (MCU-1) is the instruction B. The instruction B may be sequential to the instruction A (B=A+1), or the instruction B may be non-sequential to the instruction A (in the former case, the instruction A is referred to as a “sequential instruction”, while in the latter case, the instruction A is referred to as a “non-sequential instruction”). Likely, when the second MCU (MCU-2) is required to fetch its next instruction, it is already known that the second MCU (MCU-2) should fetch the instruction U.

Now referring to the three square waves on top of FIG. 5, in the above arrangement, from the perspective of the multiple-microcontroller as a whole, the instruction cycles are as shown in the third square wave, but from the perspective of the individual MCUs, each of them operates according to its respect instruction cycles, that is, the first MCU (MCU-1) operates according to MCU-1 instruction cycles, while the second MCU (MCU-2) operates according to MCU-2 instruction cycles. In the present invention, for distinction between the terms, an instruction cycle from the perspective of the multiple-microcontroller as a whole is referred to simply as an “instruction cycle”, while an instruction cycle from the perspective of an individual MCU is referred to as a “respective instruction cycle”. Importantly, each MCU in the above arrangement is capable of completing the execution phase of an instruction within one respective instruction cycle, even if the instruction is a non-sequential instruction; in the next respective instruction cycle, the MCU may fetch another instruction and complete its execution.

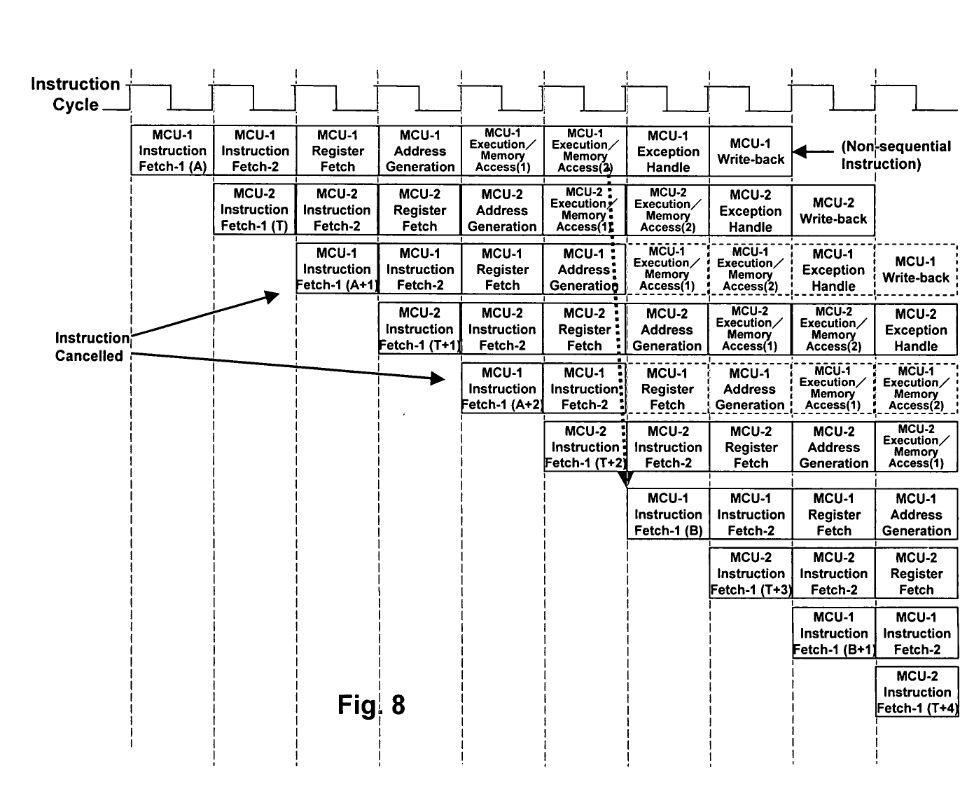

FIGS. 6 and 7 respectively show two other preferred embodiments according to the present invention. In the embodiment shown in FIG. 6, the multiple-microcontroller includes four MCUs, and it employs a 5-stage pipeline instruction execution method. As shown in the figure, after the first MCU (MCU-1) fetches the instruction A in the first instruction cycle, it is only until the fifth instruction cycle that the first MCU (MCU-1) needs to fetch another instruction; however, before the first MCU (MCU-1) is required to fetch another instruction, in the fourth instruction cycle, the first MCU (MCU-1) has completed the execution phase of the instruction A and thus it is already known that the next instruction should be the instruction B. Thus, it will never be required to cancel any instruction.

In the embodiment shown in FIG. 7, the multiple-microcontroller includes six MCUs, and it employs an 8-stage pipeline instruction execution method. As shown in the figure, after the first MCU (MCU-1) fetches the instruction A in the first instruction cycle, it is only until the seventh instruction cycle that the first MCU (MCU-1) needs to fetch another instruction; however, before the first MCU (MCU-1) is required to fetch another instruction, in the sixth instruction cycle, the first MCU (MCU-1) has completed the execution phase of the instruction A and thus it is already known that the next instruction should be the instruction B. Thus, similar to the above-mentioned embodiments, it will never be required to cancel any instruction.

As seen from the above, in the method according to the present invention, of a multiple-microcontroller includes n MCUs and employs an m-stage pipeline instruction execution method, in which the execution phase of an instruction is completed in the xth instruction cycle, then no instruction will ever need to be cancelled if n≧x. For example, if the execution phase of an instruction is completed in the (m−1)th stage of an m-stage pipeline instruction execution method, then, no instruction will ever need to be cancelled if n≧m−1, or m>n+1, as in the embodiment of FIG. 5 (n=2, m=3), or in the embodiment of FIG. 6 (n=4, m=5); and if the execution phase of an instruction is completed in the (m−2)th stage of an m-stage pipeline instruction execution method, then, no instruction will ever need to be cancelled if n≧m−2, or m≦n+2, as in the embodiment of FIG. 7 (n=6, m=8).

If a multiple-microcontroller includes relatively small number of MCUs but it is intended for the multiple-microcontroller to employ a complex pipeline instruction execution method having more stages, it may still be required to cancel certain instructions, but the loss of instruction cycles is much less than that in the conventional arrangements. This will be further explained below.

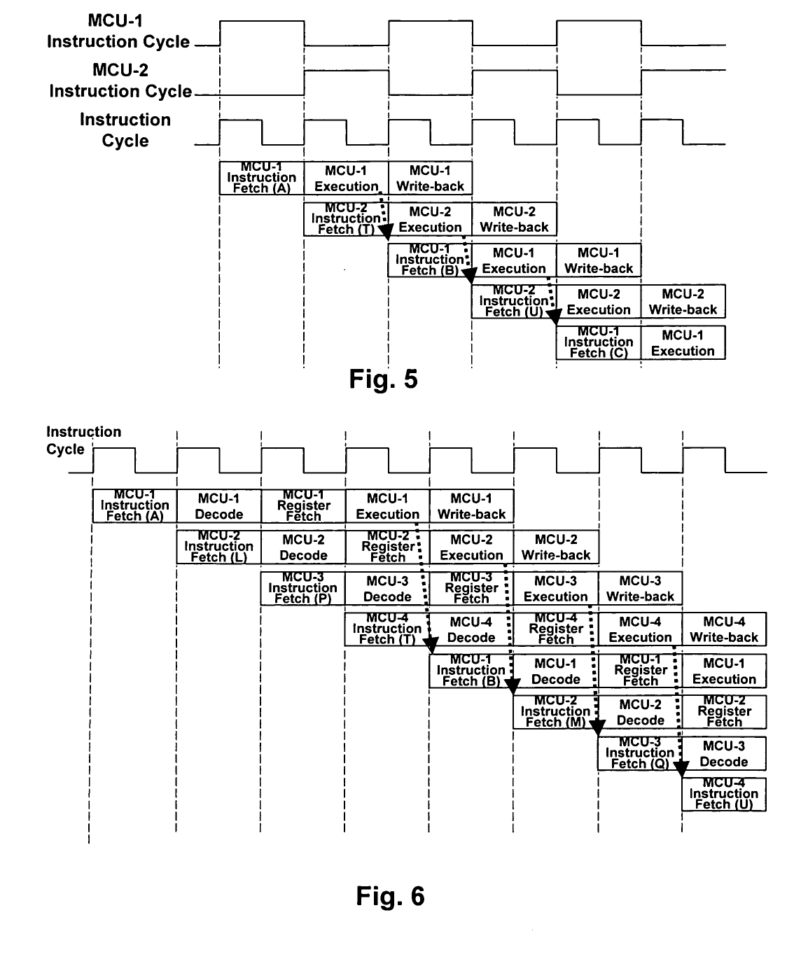

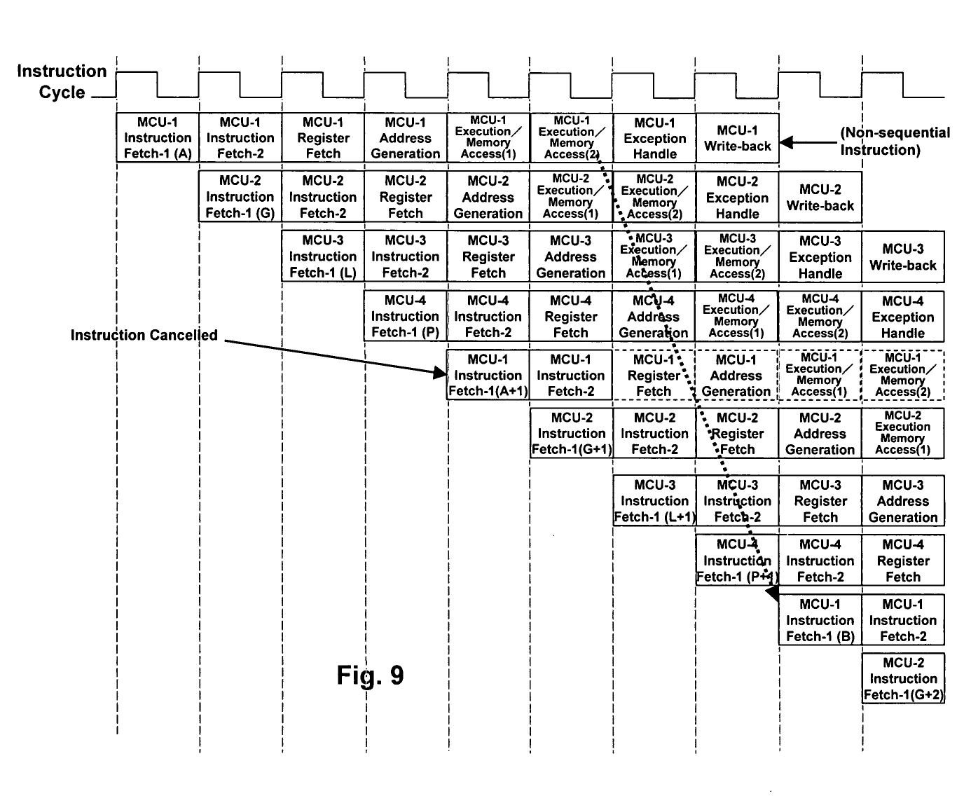

Please refer to FIGS. 8 and 9, in comparison with FIG. 4. The method according to the present invention has a better efficiency as compared with the conventional arrangements, even if it can not totally avoid cancellation of instructions. For example, in the case where an 8-stage pipeline instruction execution method is employed, and the multiple-microcontroller includes two MCUs (FIG. 8), every non-sequential instruction in the prior art shown in FIG. 4 causes a loss of five instruction cycles, while in the method according to the present invention, every non-sequential instruction causes only a loss of two instruction cycles; in the case where the multiple-microcontroller includes four MCUs (FIG. 9), every non-sequential instruction causes a loss of only one instruction cycle. Thus, even if the multiple-microcontroller includes only two MCUs, there is still great improvement of efficiency.

The general rule is thus. If the number of the MCUs is n, and the execution phase of an instruction is completed in the xth instruction cycle, then the number of loss of instruction cycles in the prior art is (x−1), while number of loss of instruction cycles in the method according to the present invention is INT_{carry}[(x/n)−1], in which INT_{carry}[ ] is to carry the number in the brackets to the next integer. The larger the numbers x and n are, the more efficient the present invention is, comparatively. For example, in the case when x=15, n=3, every non-sequential instruction in the prior art causes a loss of 14 instruction cycles, while every non-sequential instruction in the present invention causes a loss of only four instruction cycles.

In the embodiments shown above, all of the MCUs respectively fetch corresponding instructions in turn, each in a corresponding instruction cycle. That is, if the multiple-microcontroller includes n MCUs, the first MCU fetches an instruction in a first instruction cycle; the second MCU fetches an instruction in a second instruction cycle immediately following the first instruction cycle; the third MCU fetches an instruction in a third instruction cycle immediately following the second instruction cycle; . . . ; the nth MCU fetches an instruction in an nth instruction cycle immediately following the (n−1)th instruction cycle; and the first MCU fetches an instruction in an (n+1)th instruction cycle immediately following the nth instruction cycle; . . .

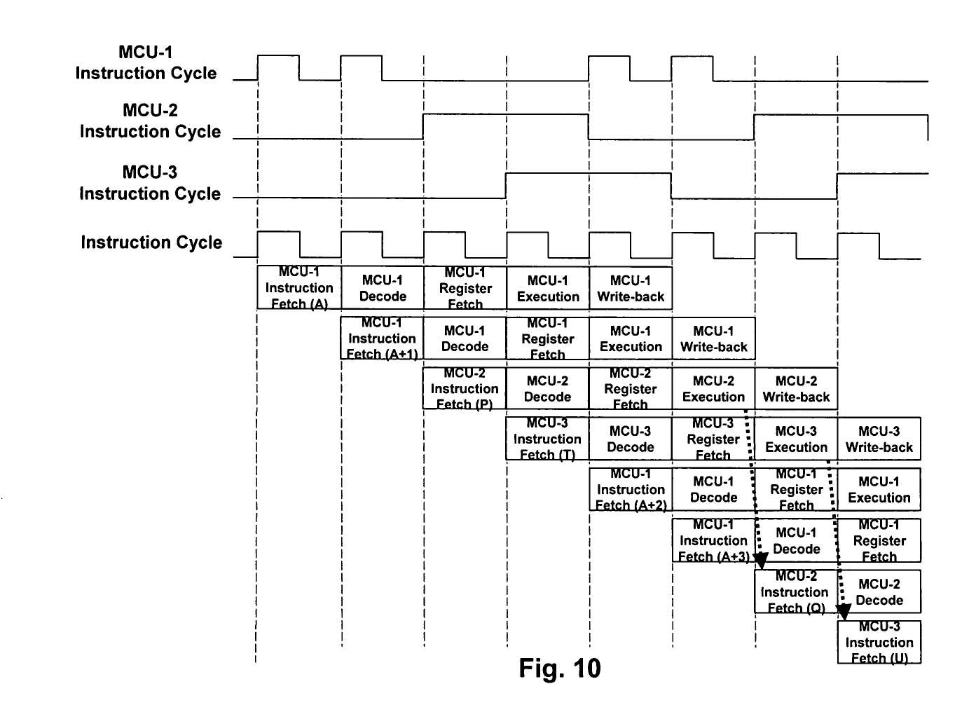

However, the above arrangement is not the only possible arrangement according to the present invention. The instruction cycles do not necessarily need to be evenly distributed to every MCU. For example, FIG. 10 shows a multiple-microcontroller having three MCUs and employing a 5-stage pipeline instruction execution method, in which both the first and the second instruction cycles are assigned to the first MCU (MCU-1), and it fetches two instructions sequentially; the third instruction cycle is assigned to the second MCU (MCU-2); and the fourth instruction cycle is assigned to the third MCU (MCU-3). The respective instruction cycles of each MCU are as shown in the square waves on top of FIG. 10. In this arrangement, instruction cancellation will never occur to the second and the third MCUs (MCU-2 and MCU-3), because they will fetch the next instruction only after they have completed the execution phase of the previous instruction. Only the first MCU (MCU-1) may have to cancel its pre-fetched instructions. Hence, a programmer may assign the second and the third MCUs (MCU-2 and MCU-3) to execute programs that require precise timing control, while assign the first MCU (MCU-1) to execute programs that do not require precise timing control. And, although the first MCU (MCU-1) may have to cancel instructions, the overall efficiency of the multiple-microcontroller as a whole is still better than the prior art, because the loss of the instruction cycles is much less.

The general rule to the arrangement shown in FIG. 10 is thus. If the number of the MCUs is n, and the execution phase of an instruction is completed in the xth instruction cycle, when n<x, a subset (or most) of the MCUs may be assigned a frequency 1/x or 1/ax of the instruction cycles of the multiple-microcontroller, in which a is an integer; the rest of the MCUs may share the rest of the instruction cycles. The MCUs operating under the frequency 1/x or 1/ax of the instruction cycles of the multiple-microcontroller will never have to cancel any instruction. In the embodiment shown in FIG. 10, n=3, x=4, the second and the third MCUs (MCU-2 and MCU-3) are each assigned ¼ of the instruction cycles, while the first MCU (MCU-1) is assigned 2/4 of the instruction cycles. Of course, this is not the only possible arrangement; other arrangements are also possible. As an example, in an 8-stage pipeline instruction execution method, in which n=4 and x=6, the assignment of the instruction cycles may be, e.g., 3/6, ⅙, ⅙, and ⅙; or 4/6, ⅙, 1/12, and 1/12; or the instruction cycles may even be dynamically assigned, such as, when an MCU is idle, dynamically assigning its instruction cycles to the first MCU (MCU-1) to speed up execution of a program that does not need precise timing control.

In summary, in comparison with the prior art, the present invention has at least the following advantages: (1) the multiple-microcontroller has a better instruction execution efficiency because none or much less instructions are cancelled; (2) it does not require a complex and area-consuming instruction prediction circuit; (3) the execution phase of non-sequential instructions may be completed within one respective instruction cycle, and thus a program which requires precise timing control may generate a desired result at a precise timing; and (4) programming is much easier.

The features, characteristics and effects of the present invention have been described with reference to its preferred embodiments, which are illustrative of the invention rather than limiting of the invention. Various other substitutions and modifications will occur to those skilled in the art, without departing from the spirit of the present invention. Therefore, all such substitutions and modifications are intended to be embraced within the scope of the invention as defined in the appended claims.

1. A pipeline instruction execution method for a multiple-microcontroller having a plurality of microcontroller units, the method comprising:
fetching a first instruction by a first one of said plurality of microcontroller units in a first instruction cycle; and
fetching a second instruction by a second one of said microcontroller units in a second instruction cycle immediately following said first instruction cycle.

2. The pipeline instruction execution method of claim 1, wherein at least one of said microcontroller units fetches an instruction only after it has obtained the address of said instruction from an immediately previous instruction.

3. The pipeline instruction execution method of claim 2, wherein every said microcontroller unit fetches an instruction only after it has obtained the address of said instruction from an immediately previous instruction.

4. The pipeline instruction execution method of claim 2, wherein everyone in a first subset of said microcontroller units fetches an instruction only after it has it has obtained the address of said instruction from an immediately previous instruction, while everyone in a second subset of said microcontroller units fetches an instruction before it has obtained the address of said instruction from an immediately previous instruction.

5. The pipeline instruction execution method of claim 1, wherein said plurality of microcontroller units fetch instructions in turn, each in a corresponding instruction cycle.

6. The pipeline instruction execution method of claim 1, wherein a first subset of said plurality of microcontroller units fetch instructions in turn, each in a corresponding instruction cycle, while a second subset of said plurality of microcontroller units fetch instructions in a different frequency than that of the first subset.

7. The pipeline instruction execution method of claim 6, wherein an execution stage of an instruction is completed in the xth instruction cycle of the instruction, and wherein everyone in said first subset of said plurality of microcontroller units has a respective instruction cycle frequency that is equal to 1/x or 1/ax of an instruction cycle of said multiple-microcontroller, in which a is an integer.

8. The pipeline instruction execution method of claim 6, wherein second subset of said plurality of microcontroller units fetch instructions in a frequency higher than that of the first subset.

9. The pipeline instruction execution method of claim 1, wherein at least one of said plurality of microcontroller units completes an execution stage of a nonsequential instruction in one respective instruction cycle.

10. (canceled)

11. A multiple-microcontroller comprising a plurality of microcontroller units each operating in corresponding respective instruction cycles, in which at least one of said plurality of microcontroller units completes an execution stage of a non-sequential instruction in one respective instruction cycle, wherein the instruction includes two or more stages.

12. The pipeline instruction execution method of claim 11, wherein said at least one microcontroller unit fetches another instruction in a next respective instruction cycle immediately following said one respective instruction cycle in which it fetches said non-sequential instruction.

13. The pipeline instruction execution method of claim 11, wherein everyone of said plurality of microcontroller units completes an execution stage of a non-sequential instruction in one respective instruction cycle.

14. The pipeline instruction execution method of claim 11, wherein an execution stage of an instruction is completed in the xth instruction cycle of the instruction, and wherein said at least one microcontroller unit has a respective instruction cycle frequency that is equal to 1/x or 1/ax of an instruction cycle of said multiple-microcontroller, in which a is an integer.
